(19) United States
(12) Patent Application Publication
(10) Pub. No.: US 2007/0178204 A1
(43) Pub. Date: Aug. 2, 2007

(54) Method for making a cold formed segmented food product

(76) Inventors: Shahnaz B. Savul, Plano, TX (US); Larry C. Swarvar, Fairview, TX (US); Nathan Griffin, Dallas County, TX (US)

Correspondence Address: CARSTENS & CAHOON, LLP, P O BOX 802334, DALLAS, TX, 75380, US

(21) Appl. No.: 11/345,829

(22) Filed: Feb. 2, 2006

(51) Int. Cl. A21D 6/00

(52) U.S. Cl. 426/503

(57) ABSTRACT

A method for creating bite-sized or segmented pieces of a cold formed bar such as a granola bar. The invention is an improved process for manipulating and shaping granola without having the granola lose its characteristic texture. In one aspect, the invention adds a rotary cutter to a conventional slabbing operation. In one aspect, the invention uses a rotary molder to force granola into female molds where it can be shaped as desired.

### BACKGROUND OF THE INVENTION

1.Technical Field

The present invention relates to the composition and process of preparing granola bars and more particularly to a method of preparing segmented granola bars.

2.Description of Related Art

Granola is a well-known product in the food industry. Granola typically comprises of cereal grains, crisp rice, binder syrup and optionally inclusions, a term in the art for pieces of fruit, nuts, or chocolate. Binder syrup is made of an aqueous solution of simple sugars such as corn syrup, glucose, or fructose.

U.S. Pat. No. 4,451,488, issued to Cook, on May 29, 1984, teaches the manufacture of chewy granola and is hereby incorporated by reference. Chewy granola is produced from the ordinary ingredients of granola with the addition of polyhydric alcohols to the binder syrup. Gylcerin and sorbitol are typical polyhydric alcohols added to the binder syrup. Table 1 lists the ingredients in a typical formulation for binder syrup used to produce chewy granola. This formulation for binding syrup includes corn syrup, granulated sugar, corn syrup solids, gylcerin, sorbitol, salt, vegetable shortening, and water, as shown by percent weight in the example listed in Table 1. The granulated sugar is constituted of one or more edible saccharides such as glucose, fructose, maltose, saccharose, honey, or molasses.

TABLE 1
Ingredients for Binder Syrup for Chewy Granola

| Ingredient | Formula wt. % |
|---|---|
| Corn Syrup | 47.0 |
| Sugar, granulated | 15.0 |
| Corn Syrup Solids | 14.0 |
| Gylcerin, usp 99% | 11.0 |
| Sorbitol solution, 70% (w/w) | 3.0 |
| Salt | 1.0 |
| Vegetable Shortening | 8.0 |
| Water | 1.0 |
| Total = | 100.0 |

Binder syrup is typically prepared by heating the gylcerin, sorbitol, shortening and corn syrup together in a tank to 120° F. The remainder of the ingredients (granulated sugar, corn syrup solids, and salt) are then added to the tank. This mixture is heated to 130° F.; once it has reached this temperature, it is ready to be mixed with the other ingredients of chewy granola shown in Table 2.

A typical chewy granola comprises granola cereal, crisp rice, binder syrup (such as that described above), and inclusions. An example of a specific formulation is shown in Table 2. In this application, all percentages are by weight unless otherwise specified.

TABLE 2
Ingredients for a Typical Chewy Granola

| | Formula wt. % |
|---|---|
| Ingredient | (With Inclusions) |
| Granola Cereal | 47.0 |
| Crisp Rice | 8.0 |
| Binder Syrup (see Table 1) | 34.0 |
| Inclusions | 11.0 |
| Total = | 100.0 |

The process to create granola bars is relatively straightforward and is shown in FIG. 1. The ingredients 10 are serially added to a continuous mixer 15. The cereal grains and rice are added first, the binder syrup is added second and the inclusions are added last. The inclusions are added last because they may be susceptible to melting from the relatively hot binder syrup. Also, the inclusions are more susceptible to mechanical breakdown and should receive as little processing time as possible.

The mixture at this stage is between ambient temperature (typically 70° F.), and the temperature of the binder syrup (about 130° F.). The overall mixture of granola ingredients, or chewy granola, at this stage is about 6% water by weight. Manufacturers typically use a continuous flow interrupted flight or paddle mixer for production because it mixes the ingredients in the shortest amount of time, transfers the least amount of energy to the ingredients, and causes relatively little mechanical breakdown.

The granola mixture at this point is transferred onto a slabbing conveyor 20 where the mixture is compressed with compression rollers 25 to a desired thickness, typically one-half inch. A typical slabbing conveyor is about three feet in width. The mixture is partially cooled 35 as it is rolled out. The slab is sliced 50 and then cut into rectangular bars with a guillotine cutter 60. Each granola bar at this point is about three and one-half inches in length, one to one and one-half inches wide, and weighs between 28 and 35 grams. The bars are cooled 70 to ambient temperature, about 70° F., and packaged 80. The final overall water content is about 6%, about the same as when the granola mixture entered the production process. The composition of the granola does not change throughout the production process.

A traditional apparatus for slabbing, compressing, and cutting granola is illustrated in FIG. 2a and FIG. 2b. FIG. 2a and FIG. 2b are both schematic representations of the process where FIG. 2a is a head-on view and FIG. 2b is a side view. With reference to FIGS. 2a and 2b, the granola mixture is transferred along a conveyor table 21 from left to right on a conveyor belt 23 (shown in FIG. 2a, but hidden from view in FIG. 2b). The mixture passes beneath a series of product rollers 22 in a void space 24 where the mixture is gradually compressed to a desired thickness, typically one-half inch, creating a continuous sheet of product. After compression, the granola mixture is cooled and passes through a slab slicer 50 in order to divide the continuous sheet into multiple lanes of product. These lanes are then cut into bars by a guillotine cutter 60 before being cooled to roughly ambient temperature and sent to packaging.

The traditional production process is limited in several ways. One limitation is the slicing and cutting speed. The typical production rate is about 6,000 pounds per hour. The conveyor table 24 and guillotine cutter 60 limit the form of granola bars to a rectangle bar. The guillotine cutter 60 is economically bound to operate within a specific range of operation. It is undesirable for the guillotine cutter 60 to cut granola into smaller bars or pieces because for each cut, granola generates non-recyclable waste fragments. The ratio of waste to finished product increases as the size of the finished granola product decreases. Thus, the smaller the pieces, the higher the waste and hence expense of the product. Another economic limitation is related to production speed. A bite-sized piece of granola is difficult to produce because either the cutting speed may have to be increased beyond its normal limit, or the line speed may have to be slowed with a concomitant reduction in production efficiency. For example, a Quaker Chewy® granola bar is typically about 1.125 inches wide and 3.62 inches long and weighs 29 grams. A line speed of 18 feet per minute requires the guillotine cutter 60 to operate at approximately 60 cuts per minute and yields approximately 6,400 pounds of product per hour. A bite sized piece that is about 1.125 inches wide and 1.125 inches long would require a guillotine cutter 60 to run at 192 cuts per minute to maintain the same line speed and accompanying production rates. Unfortunately, guillotine cutters cannot presently operate faster than 180 cuts per minute. Thus, even when the guillotine cutter operates at the maximum possible speed of 180 cuts per minute, line speed drops to 16.9 feet per minute. Thus, when smaller pieces are produced, overall production is slowed, which results in a higher costs of operation.

There are other known substitutes for cutting granola into bars, but they operate at even slower speeds than the guillotine cutter 60. For example, a Bepex brand ultrasonic guillotine is limited to 80 cuts per minute. A water knife cutter, which makes cuts as it travels back and forth across the belt width, can travel only 100 feet per minute. Thus, for belt width of approximately 3 feet, there is a maximum of only 33 cuts per minute.

Another limitation arises in the traditional production process because Granola is not susceptible to significant manipulation during production because its texture is easily destroyed. The dry grains of granola are susceptible to mechanical destruction and are generally not suited to extrusion or other similar processing.

Accordingly, a need exists for an improved apparatus and method to economically create, in large quantities, a segmented food bar such that a consumer can break bite-sized pieces or segments from the food bar. Further, a need exists for an apparatus and method to create a food bar from a cold-formable dough including a granola-type dough that can be formed into an arbitrary shape or form. Finally, a need exists for a method to create a granola bar having integral bite-sized pieces or segments where the granola maintains its traditional and expected texture, appearance and flavor.

### SUMMARY OF THE INVENTION

The proposed invention comprises a novel process to generate a segmented food bar such that a consumer can separate the segments to create bite-sized portions. The present invention comprises the steps of first making a cold formable dough and then forming the dough into a segmented food bar. The invention discloses two embodiments to achieve this objective.

In one embodiment, the cold formable dough is made into a slab by a plurality of compression rollers. The dough slab moves along a conveyor where an impression roller makes a series of transverse indentations or partial cuts through the slab to make a segmented slab. The spaces between these indentations define the segments. In one embodiment, the segmented slab is cut into discrete bars having at least two segments by slicing the slab into strips in the longitudinal direction and cutting the slab transversely with a guillotine cutter.

In an alternative embodiment, the cold formable dough is placed into a rotary molder comprised of a pair of rollers below a hopper for the cold formable dough. One of the rollers comprises a plurality of female molds. As the rollers turn inward toward each other, the cold formable dough is forced into the molds and thereby takes the shape of the mold and forms a segmented food bar. The segmented food bar is then ejected from the mold.

In one embodiment, the segmented food bar of the present invention has an appearance and texture substantially similar to chewy or crunchy granola bars produced by prior art methods with the traditional and expected texture, appearance and flavor of chewy granola.

The above as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart of the typical prior art process for forming a granola bar product;

FIG. 2a is a head-on schematic view of a typical slabbing conveyor used to roll a granola bar product;

FIG. 2b is horizontal schematic view of the same slabbing conveyor of FIG. 2a showing the compression rollers, slicer, and guillotine cutter used to form granola bar product;

FIG. 3a is a flow chart showing the process for forming segmented granola bars pursuant to one embodiment of the present invention;

FIG. 3b is a horizontal schematic view of a slabbing conveyor in accordance with one embodiment of the present invention;

FIG. 3c is a side schematic view of the rotary cutter in accordance one embodiment of the present invention;

FIG. 4a is a flow chart showing the process for forming segmented granola bars in accordance with an alternative embodiment of the present invention;

FIG. 4b is a perspective view of a rotary forming apparatus in accordance with one embodiment of the present invention; and

FIG. 5 is a perspective view of a resultant segmented granola bar formed in accordance with one embodiment of the present invention.

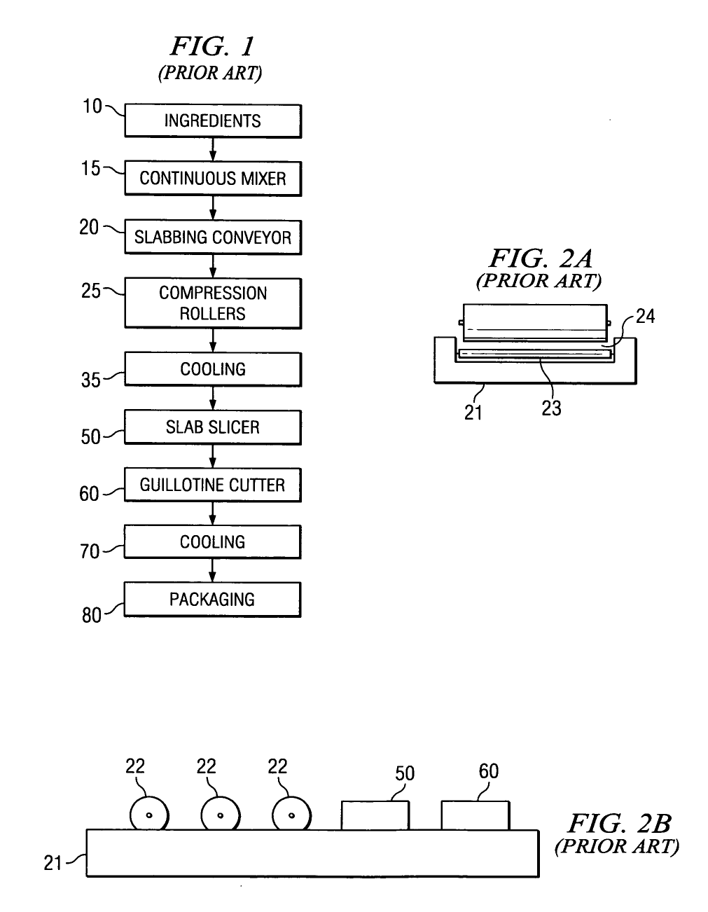

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

### DETAILED DESCRIPTION

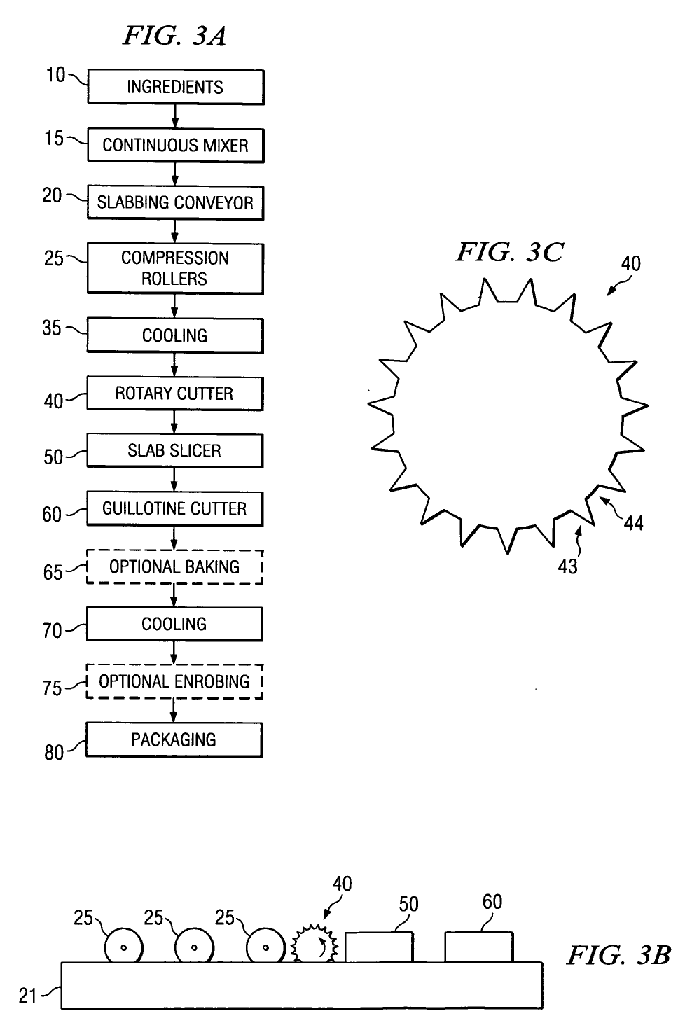

FIG. 3a is a flow chart showing the process for forming segmented granola bars pursuant to one embodiment of the present invention. First, food ingredients 10 are mixed 15 into a dough and the dough is formed into a slab on a slabbing conveyor 20. In one embodiment, the dough is formed from food ingredients 10 selected from the group consisting of grains, legumes, fruits, nuts, chocolate chips, vegetables, polyhydric alcohols, water and combinations thereof to form a dough. In one embodiment, a binder syrup can also be used. Examples of ingredients that can be used to produce doughs can be found in U.S. Pat. Nos. 4,461,488, 4,871,557, 6,773,734, and U.S. Pat. App. No. US-2005-0053697-A1, assigned to the same assignee as the present invention. Further, although the present invention is directed towards granola-type products, the invention can apply to any cold-formable dough. As used herein a cold-formable dough is defined as a suitably ductile dough such that it can be shaped or formed and is cohesive enough to retain its shape at its forming temperature. The forming temperature is preferably less than about 100° F., more preferably less than about 92° F. and most preferably between about 85° F. and about 92° F. Any set of food ingredients or particulates that can be made into a cold-formable dough can be used.

FIG. 3b is a horizontal schematic view of a slabbing conveyor in accordance with one embodiment of the present invention. Referring to FIGS. 3a and 3b, after the dough is placed on the slabbing conveyor 20, it next compressed with compression rollers 25 to a desired thickness. The dough is then partially cooled 35 as it is rolled out along the slab conveyor in the longitudinal direction towards an impression roller or rotary cutter 40 having a plurality of teeth or spikes about the outer radius. As the rotary cutter 40 rotates, a first spike will make a first partial cut or indentation through the slab in the transverse direction. As the ductile dough slab moves along the slab conveyor a second spike will make a second partial cut or indentation through the ductile dough slab in the transverse direction thereby defining a segment between the first and second cuts.

Next, the segmented slab is sliced 50 into a plurality of strips and then cut into bars with a guillotine cutter 60. In one embodiment, the segmented slab is the width of the final food bar and no slicing step is required. In one embodiment, each segmented food bar at this point comprises four segments, each segment is between about ½ inch and about 1½ inches in length. In this embodiment, the granola bar is about 3 to about 5 inches in length, about ½ to about 1 1/2 inches wide, and about ¾ inches to about 1¼ inches tall and weighs between 28 and 35 grams. In one embodiment, the segmented food bar comprises at least two segments. In one embodiment each segment weighs between about 5 and about 10 grams. These ranges are provided for purposes of illustration and not limitation.

In one embodiment, the segmented granola bars are next baked 65 in an oven to remove the extra water to make a crunchy granola bar. In one embodiment, the granola pieces are transported through the oven on a sheet metal conveyor made of solid carbon steel. In one embodiment, the baking 65 process is carried out at a sufficiently low temperature to dry the chewy granola, but not to overly modify or cook the same. This can be accomplished by drying the granola in an oven for 5-15 minutes at a temperature of less than about 400° F. In one embodiment, the baking 65 step is achieved by baking for about 10 minutes at 370° F. In an alternative embodiment, the segmented bars are dried such that the water content is less than 4% by weight. In one embodiment, the segmented bars are dried in an oven for 10-20 minutes at a temperature greater than 250 ° F. The segmented bars can then be cooled 70 by cooling fans blowing ambient or chilled air over the segmented bar after the either the guillotine cutter 60 or the optional baking step 65.

After cooling 70, in one embodiment, the segmented bar is fully or partially enrobed 75 in chocolate or other material. In one embodiment, the segmented bar is partially bottom-coated or enrobed by routing the segmented bars on a chain link conveyor submerged in chocolate or other material. In one embodiment, the segmented bar is completely enrobed in chocolate or other material. The granola pieces can then transported along conveyor belts to be packaged 80.

FIG. 5 is a perspective view of a resultant segmented granola bar formed in accordance with one embodiment of the present invention. As shown in FIG. 5, the segmented food bar 100 comprises four segments 102 104 106 108. The first segment 102 and second segment 104 are separated by an indentation 103. The distance D from the indentation 103 to the bottom of the bar 100 can be manipulated as desired depending upon several factors including the rigidity of the food bar and desired ease of separation of segments 102 104. The rigidity of the food bar, for example, can be important if a food bar is desired that produces minimal sag when held by one of the end segments 102 108. Further, the distance D can differ based upon the inherent strength of the food bar. For example, a brittle, crunchy granola bar may require a shorter distance than a more ductile, chewy granola bar. Moreover, whether the food bar is enrobed can also be a factor in determining the desired distance D, as enrobing can add to the strength of the bar. In one embodiment, the distance D is between about ⅛ and about ½ inches.

FIG. 3c is a side schematic view of the rotary cutter in accordance one embodiment of the present invention. Referring to FIGS. 3c and 5, the length and geometry of the resultant segments can be manipulated by changing the length 44 between spikes and the geometry of the spikes 43. Further, the depth of the partial cut or indentation imparted by the rotary cutter 40 can be manipulated to achieve the desired distance D. In one embodiment, the length 44 between spikes is between about ¼ and ¾ inches and the spike 43 height is between about ¼ to about 1 inches. In one embodiment, distance from the center of the rotary cutter 40 to the base of the spike (e.g. inside radius) is between about 2 and about 3 inches. It should be pointed out that while the spikes 43 are shown to be triangular in shape, such example is given for purposes of illustration and not limitation. In one embodiment, the tip of the spike 43 is rounded and has a radius of curvature of between about 1/32 inches to about ⅛ inches. In one embodiment, all or a portion of the spikes 43 and/or the portion between the spikes 44 comprises a fluoropolymer -coated stainless steel. In one embodiment, the temperature of the rotary cutter 40 is adjusted to facilitate removal of the dough from the cutter 40. The temperature can be adjusted accordingly, by for example, jacketing the cutter 40 with hot or cold water. In one embodiment, the water temperature is between about 40° F. and about 60° F. and more preferably between about 43° F. and 56° F. One advantage of the present invention is that, in one embodiment, many shapes of a segmented bar can be made with little or no resultant scrap. This is because the rotary cutter does not actually cut the cold formed bar, but rather, through compression, forms an indention in the cold formed dough.

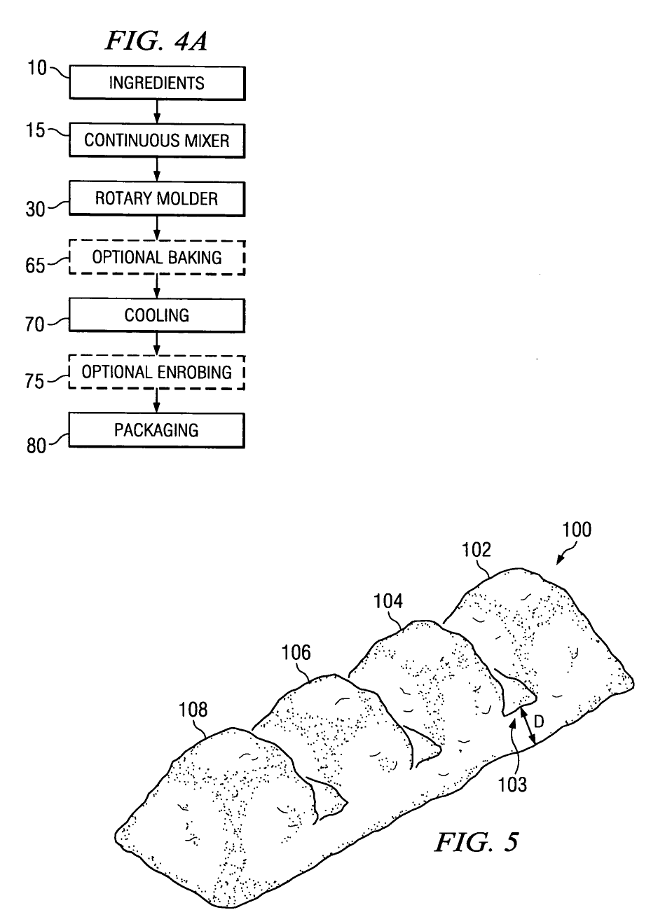

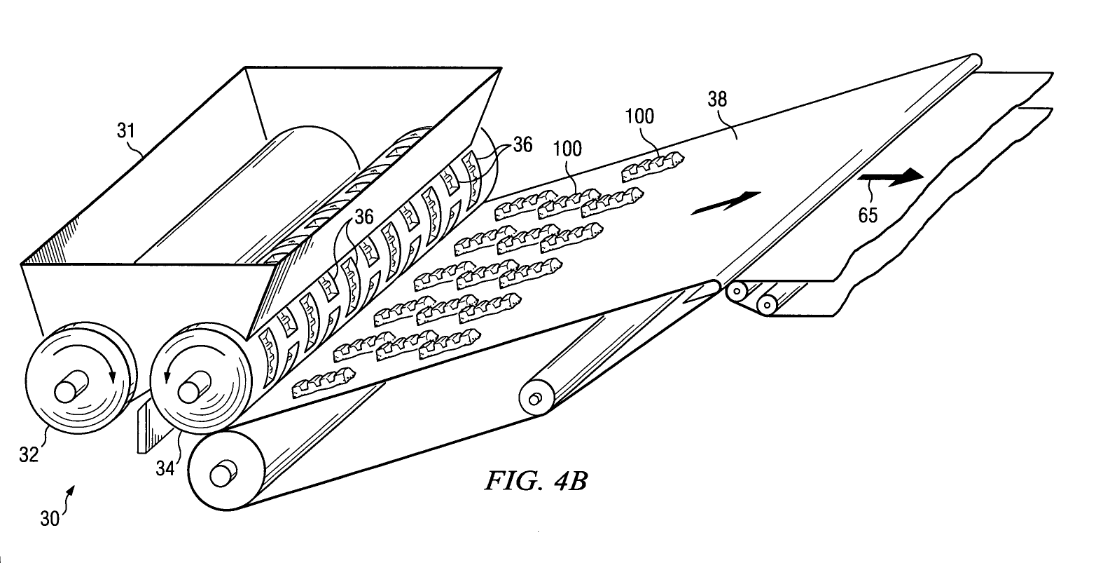

FIG. 4a is a flow chart showing the process for forming segmented granola bars in accordance with an alternative embodiment of the present invention. First, food ingredients 10 are mixed 15 into a dough for processing in a rotary molder 30. Rotary molders 30 are known in the art and are commonly used to provide high definition to cookie or confectionery products, but have not been heretofore used to provide general shape to cold formed doughs, including granola-type bars. FIG. 4b is a perspective view of a rotary molder or forming apparatus in accordance with one embodiment of the present invention. Any rotary molder can be used. A rotary molder 30 comprises a pair of rollers 32 34 below a hopper 31 for storing a dough. The rollers 32 34 turn inward toward each other, the first roller 32 turning in a clockwise fashion and the second roller 34 turning in a counterclockwise fashion. The second roller 34 comprises a plurality of female molds 36. The molds 36 can be designed to shape the dough into segmented bars. The granola is forced through the rollers 32 34, into the molds 36, and is then released from the molds 36 and onto a wetted cotton belt conveyor 38. The scraper, adjacent the second roller 34, forces the dough into the mold cavities 36 where the dough takes the shape of the mold 36. In one embodiment, the second roller 34 comprises between about 4 and about 11 molds 36 across the width of the roller and about 4 to about 10 molds 36 around the circumference of the roller 34. In one embodiment, the roller 34 is between about 9 and about 12 inches in diameter and about 8 to about 40 inches in width. Such measurements are provided for purposes of illustration and not limitation.

As the second roller 34 engages the wetted cotton belt conveyor 38, the segmented bars 100 are pulled by friction onto the conveyor belt 38. In one embodiment, the mold cavities 36 are coated with a flouropolymer. Referring back to FIG. 4a, the segmented bars can then be routed to an optional baking step 65, cooling 70, optional enrobing and packaging 80 as described above. One advantage of the rotary molder embodiment depicted in FIG. 4a and 4b is that it that can produce a segmented bar with fewer unit operations than the embodiment depicted in FIGS. 3a and 3b that incorporates the rotary cutter into the standard conveyor table 21. Another advantage of the rotary molder embodiment is that because fewer unit operations are required, the rotary molder is easy to place into a food processing line and requires less space than a traditional slab conveyor embodiment.

There are numerous advantages provided by the instant invention. First, the instant invention discloses a novel method for making a segmented food bar from a cold formable dough. The segments or bite-size pieces can be easily separated from the food bar by the consumer. The invention provides a novel way to shape a cold formable dough, including a granola dough into an arbitrary shape or form. Further, the instant invention discloses one embodiment whereby an existing slab conveyor used to process granola can be easily converted to produce a segmented granola bar having bite sized pieces. Finally, the instant invention provides a method for economically making large quantities of a segmented granola bars whereby the granola maintains its traditional and expected texture, appearance and flavor.

While the invention has been particularly shown and described with reference to a preferred embodiment, it will be understood by those skilled in the art that various changes in form and detail may be made therein without departing from the spirit and scope of the invention. For example, the dimensions may be changed to increase or decrease the overall size of the cold formed bars; the shapes of the granola pieces may be changed; and the granola composition may be varied to adjust the texture and flavor of the final product, and to accommodate various flavor combinations and/or inclusions. Further, the means for cutting the product need not be one particular type, but could include any number of commonly available cutting devices. Different thicknesses of the final product may be desired. The overall intent of this invention is to create a cold-formed segmented food bar.

What is claimed is:

1. A method for making a cold formed segmented food bar, said method comprising the steps of:
(a) mixing ingredients together into a cold formable dough;
(b) forming said cold formable dough into a segmented food bar.

2. The method of claim 1 further comprising the step of baking said food bar in an oven for between about 5 to about 15 minutes at a temperature of less than about 400° F. after step b).

3. The method of claim 1 further comprising the step of partially or completely enrobing said food bar after step b).

4. The method of claim 1 wherein said cold formable dough consists of ingredients selected from the group of grains, legumes, fruits, nuts, chocolate chips, vegetables, polyhydric alcohols, water, and combinations thereof.

5. The method of claim 1 wherein the forming at step b) comprises the steps of:
lacing said cold formable dough on a slab conveyor moving in a longitudinal direction;
compressing said cold formable dough to make a dough slab with at least one compression roller;
using a rotary cutter having a plurality of teeth about an outer radius to make a first indentation and a second indentation through said slab, wherein a segment is defined between said first and second indentations, and wherein said first and said second indentations are in a transverse direction; and
cutting said strips in the transverse direction to form a plurality of bars, each bar having at least two segments.

6. The method of claim 5 further comprising the step of slicing said slab after said compressing step to separate the slab into a plurality of strips, wherein said slice is in a longitudinal direction.

7. The method of claim 5 wherein said rotary cutter further comprises a flouropolymer coating.

8. The method of claim 5 wherein a distance from said first indentation to a slab bottom is between about ⅛ and about ½ inches.

9. The method of claim 1 wherein the forming at step b) comprises the step of:
placing said dough into a hopper in communication with a rotary molder, said rotary molder comprising a pair of rollers below said hopper wherein said one of said rollers comprises a plurality of female molds;
forcing said dough through said rollers and into said female molds to form a segmented food bar; and
releasing said segmented food bar from said rollers.

10. The method of claim 9 wherein said female molds comprise a fluoropolymer coating.

11. A method for making a cold formed segmented food bar, said method comprising the steps of:
a) mixing ingredients together into a cold formable dough;
b) placing said cold formable dough on a slab conveyor moving in a longitudinal direction;
c) compressing said cold formable dough to make a dough slab with at least one compression roller;
d) using a rotary cutter having a plurality of teeth about an outer radius to make a first indentation and a second indentation through said slab, wherein a segment is defined between said first and second indentations, and wherein said first and said second indentations are in a transverse direction; and
e) cutting said strips in the transverse direction to form a plurality of bars, each bar having at least two segments.

12. A method for making a cold formed segmented food bar, said method comprising the steps of:
a) mixing ingredients together into a cold formable dough;
b) placing said dough into a hopper in communication with a rotary molder, said rotary molder comprising a pair of rollers below said hopper wherein said one of said rollers comprises a plurality of female molds;
c) forcing said dough through said rollers and into said female molds to form a segmented food bar; and
d) releasing said segmented food bar from said rollers.
